(19) United States
(12) Patent Application Publication
(10) Pub. No.: US 2014/0050343 A1
(43) Pub. Date: Feb. 20, 2014

(54) BTE HEARING AID WITH AN ELONGATED SECURING MEMBER

(71) Applicants: Hans Henrik Bjorstrup, Vaerlose (DK); Jan Johansen, Koge (DK); Brian Jeppesen, Frederiksberg (DK)

(72) Inventors: Hans Henrik Bjorstrup, Vaerlose (DK); Jan Johansen, Koge (DK); Brian Jeppesen, Frederiksberg (DK)

(73) Assignee: GN ReSound A/S, Ballerup (DK)

(21) Appl. No.: 13/990,411

(22) PCT Filed: Dec. 23, 2011
(86) PCT No.: PCT/EP2011/073966

§ 371 Date: Sep. 10, 2013

(30) Foreign Application Priority Data
Dec. 23, 2010 (DK) PA2010 01183
Mar. 15, 2011 (EP) 11158297.9

(51) Int. Cl. H04R 25/00

(52) U.S. Cl. CPC H04R 25/60
USPC 381/330

(57) ABSTRACT

A BTE hearing aid includes: a hearing aid housing configured to be worn behind a pinna; a sound signal transmission member for transmission of a hearing loss compensated output signal from a first end of the sound signal transmission member to an ear canal of a user at a second end of the sound signal transmission member; a connector at the first end of the sound signal transmission member for coupling the sound signal transmission member with the housing; and an elongated securing member with a first end coupled with the hearing aid housing, and a second end, the second end of the elongated securing member being a free end; wherein the elongated securing member extends from its first end along at least a part of the hearing aid housing, and is for improved retention of the hearing aid housing in its intended position behind the pinna.

### RELATED APPLICATION DATA

This application is the national phase of International patent application No. PCT/EP2011/073966, filed on Dec. 23, 2011, which claims priority to and the benefit of Danish patent application No. PA 2010 01183, filed on Dec. 23, 2010, and European patent application No. 11158297.9, filed on Mar. 15, 2011. The entire disclosures of all of the above applications are expressly incorporated by reference herein.

### p FIELD

The present disclosure relates to BTE (Behind-The-Ear) hearing aids with an elongated securing member for improved retention of the hearing aid housing in its intended position behind the pinna of the user.

### BACKGROUND

BTE (behind-the-ear) hearings aids are well-known in the art. A BTE hearing aid has a housing that is shaped to be worn behind the pinna of the user. The housing accommodates components for hearing loss compensation. A sound signal transmission member, i.e. a sound tube or an electrical conductor, transmits a hearing loss compensated sound output signal from the housing into the ear canal of the user.

In order to position the sound signal transmission member securely and comfortably in the ear canal of the user, an earpiece, shell, or earmould may be provided for insertion into the ear canal of the user.

Typically, the earpiece, shell, or earmould is individually custom manufactured or manufactured in a number of standard sizes to fit the user's ear to sufficiently secure the sound signal transmission member in its intended position in the ear canal and prevent the earpiece from falling out of the ear, e.g., when the user moves the jaw.

The sound signal transmission member may be a sound tube for propagation of sound signals as acoustic signals from a receiver positioned in the BTE hearing aid housing and through the sound tube to an earpiece positioned and retained in the ear canal of the user and having an output port for transmission of the sound to the eardrum in the ear canal.

The sound signal transmission member may alternatively comprise electrical conductors for propagation of electrical audio signals from the output of a signal processor in the BTE hearing aid housing through the conductors to a receiver positioned in the earpiece for emission of sound through an output port of the earpiece.

EP 1 448 014 A1 discloses a BTE hearing aid with a sound tube and an earpiece that is shaped for insertion into an ear canal of a user and has an elongated securing member connected to the earpiece and denoted a fibre for abutting a lower part of the concha when the earpiece has been inserted in the ear canal thereby providing retention of the earpiece in the ear canal of the user. The sound tube has a pre-formed shape that includes a first bend extending from the hearing aid housing over the top of the ear of the user and a second bend extending from outside the ear canal and into the ear canal of the user.

During normal use, the hearing aid housing of the BTE hearing aid is sufficiently secured in its intended position behind the pinna wedged between the pinna and the head of the user and also kept in position by the sound signal transmission member fixed in the ear canal and hanging on the top part of the interconnection between the pinna and the head of the user, i.e. across the top part of the auricular sulcus.

However, when the user moves around in a non-relaxed way, such as when doing exercises, going in for sports, playing, etc, improved retention of the hearing aid housing in its intended position behind the pinna in the auricular sulcus would be useful.

Also, smaller and smaller BTE hearing aid housings have emerged recently showing reduced capability of retention in its intended position behind the pinna.

### SUMMARY

A BTE hearing aid is provided with an elongated securing member for improved retention of the hearing aid housing in its intended position behind the pinna of the user.

The elongated securing member extends between a first end interconnected with the hearing aid housing and a second free end and abuts an outer surface of the auricular sulcus when the hearing aid housing is positioned in its intended position behind the ear of the user, whereby the elongated securing member assists in gripping around the pinna in the auricular sulcus thereby providing improved retention of the hearing aid housing in its intended position behind the pinna of the user.

The BTE hearing aid has a sound signal transmission member for transmission of a hearing loss compensated output signal from a sound output of the hearing aid housing at a first end of the sound signal transmission member to the ear canal of the user at a second end of the sound signal transmission member.

Preferably, the sound signal transmission member has a connector at its first end for interconnection of the sound signal transmission member with the housing.

Throughout the present disclosure, a mechanical part is interconnected with another mechanical part when the two parts are directly connected or fastened to each other, i.e. in abutting contact with each other; or when each of the two parts are both directly connected to the same third mechanical part; or when each of the two parts are both directly connected to a plurality of other interconnected mechanical parts, one of which is directly connected to one of the two parts and another of which is directly connected to the other of the two parts.

Throughout the present disclosure, one mechanical part is in engagement with another mechanical part when they are interconnected with one another.

The first end of the elongated securing member is interconnected with the hearing aid housing at the sound output of the hearing aid housing in engagement with the connector.

In this way, the elongated securing member is preferably interconnected with the hearing aid housing at a distance from the part of the hearing aid housing accommodating a battery door and possible other parts of a user interface, such as an on/off switch, of the hearing aid so that the elongated securing member is prevented from interfering with user access to the user interface whereby user operation of the hearing aid is not made more cumbersome by the presence of the elongated securing member.

The interconnection of the sound signal transmission member to the hearing aid housing and the interconnection of the elongated securing member to the hearing aid housing may be combined or may otherwise cooperate. The sound signal transmission member may for example be interconnected with the elongated securing member and they may be interconnected with the hearing aid housing together, e.g. the sound signal transmission member and the elongated securing member may be moulded and moulded together in the same moulding process, and possibly moulded together with the connector for interconnection with a mating part of the hearing aid housing at the sound output of the hearing aid housing.

The connector may be a hook having a first end that is interconnected with the sound output of the hearing aid housing and a second end that is interconnected with the sound signal transmission member and that resides across the top part of the auricular sulcus when the hearing aid is positioned in its intended position behind the pinna of the user.

Throughout the present disclosure, the words “top”, “bottom”, “upward”, and “downward” relate to the orientation of an ear and of a BTE hearing aid worn behind the ear by a standing or sitting user.

The elongated securing member may have a ring-shaped connector at its first end that is positioned around the connector, e.g. the hook, when the elongated securing member is interconnected with the hearing aid housing, and thus, the elongated securing member is interconnected with the hearing aid housing in engagement with the connector. Part of the ring-shaped connector may overlap or be positioned around the hearing aid housing. The ring-shaped connector need not form a continuous ring: rather the ring-shaped connector may have an opening and form a pair of tongs gripping around the connector, e.g. the hook, when the elongated securing member has been attached to the connector, e.g. the hook.

Alternatively, the elongated securing member may have a ring-shaped connector at its first end that is positioned and attached between the connector, e.g. the hook, and the hearing aid housing and thus, the elongated securing member is interconnected with the hearing aid housing in engagement with the connector. The ring-shaped connector need not form a continuous ring: rather the connector may have an opening and form a pair of tongs.

The elongated securing member may have a pre-formed arcuate shape that corresponds to the arcuate shape of the surface of the auricular sulcus facilitating abutment of the elongated securing member with the auricular sulcus so that the elongated securing member in cooperation with other parts of the BTE hearing aid provides a retaining grip around the bottom of the auricular sulcus formed by the interconnection of the pinna with the head of the user.

The elongated securing member may be flexible facilitating adaption of the arcuate shape of the elongated securing member to the actual arcuate shape of the surface of the auricular sulcus of the user in question and for improved user comfort. The flexibility allows the elongated securing member to change its arcuate shape in response to possible changes of the arcuate shape of the auricular sulcus of the user, e.g. due to movement of the jaw of the user, such as during chewing, yawning, smiling, talking, eating, etc.

The elongated securing member may be resilient for improved retention of the hearing aid housing in its intended position behind the pinna of the user. The elongated securing member may for example be manufactured with an arcuate shape having a smaller radius of curvature than the corresponding arcuate shape of the auricular sulcus of the intended user, so that when the hearing aid housing is positioned in its intended position behind the pinna of the user the elongated securing member exerts an elastic pinching force around the pinna for improved retention of the hearing aid housing in its intended position and substantially without sacrificing user comfort.

The elongated securing member may be manufactured in a material that can be shaped by the user whereby the user is allowed to adapt the elongated securing member to the arcuate shape of the surface of the auricular sulcus of the user. When no force is applied to the elongated securing member, the elongated securing member maintains its current shape possibly with some flexibility for user comfort. For example, the elongated securing member may have a metal wire inserted into a plastic tube allowing a user to bend the tube with the wire to any desired shape. After bending, the wire maintains its current shape.

Different parts of the elongated securing member may be made of different materials with different properties. For example:

The upper part of the connector of the elongated securing member may be made of an elastic material. The diameter of the upper part may be smaller than the diameter of the part of the hearing aid where the elongated securing member is connected to the hearing aid. The use of an elastic material in combination with an undersized diameter as compared to the diameter of the hearing aid at the point of connection allows for the connector of the elongated securing member to fit tightly around the hearing aid like an elastic band.

The lower part of the connector of the elongated securing member may be made of a hard material. The use of a hard material for the connector of the elongated securing member provides a rigid connection to the elongated securing member.

Furthermore, when made of a hard material, the inner contour of the lower part of the connector of the elongated securing member may be shaped to match the outer contour of the part of the hearing where the connector of the elongated securing member is connected to the hearing aid. This results in a rigid interconnection of the connector with the hearing aid.

The material of the connector may be gradually varied from a hard material at the lower part of the connector where the connector is attached to the elongated securing member to an elastic material at the top part of the connector of the elongated securing member.

The connector may be made of rubber which is attached to the elongated securing member.

The connector may be made of a hard material. The inner contour of the connector can be shaped to match the outer contour of the part of the hearing aid where the connector of the elongated securing member is attached to the hearing aid.

The upper elongated part of the elongated securing member may be made of a hard material. The use of a hard material for the upper part of the elongated securing member provides a rigid connection of the connector of the elongated securing member to the elongated securing member. Further, the elongated securing member will follow the shape of the hearing aid at the point of connection. This ensures that the securing member does not affect the placement of the hearing aid relative to its intended position behind the ear.

The contour of the upper part of the elongated securing member facing the hearing aid can be shaped to follow the contour of the part of the hearing aid where the securing member is attached to the hearing aid. In this way, the elongated securing member may form an integral part of the hearing aid.

The material of the lower part of the elongated securing member may be resilient for improved retention of the hearing aid housing in its intended position behind the pinna of the user and may for example be manufactured with an arcuate shape having a smaller radius of curvature than the corresponding arcuate shape of the auricular sulcus of the intended user, so that when the hearing aid housing is positioned in its intended position behind the pinna of the user the lower part of the elongated securing member exerts an elastic pinching force around the pinna for improved retention of the hearing aid housing in its intended position and substantially without sacrificing user comfort.

The lower part of the elongated securing member may be manufactured in a material that can be shaped by the user whereby the user is allowed to adapt the lower part of the elongated securing member to the arcuate shape of the surface of the auricular sulcus of the user. When no force is applied to the lower part of the elongated securing member, the lower part of the elongated securing member maintains its current shape possibly with some flexibility for user comfort. For example, the lower part of the elongated securing member may have a metal wire inserted into a plastic tube allowing a user to bend the tube with the wire to any desired shape. After bending, the wire maintains its current shape.

The lower part of the elongated securing member may be produced from a material, which can be formed in a pre-formed shape and exhibits sufficient rigidity to hold the hearing aid housing behind the pinna and retains its shape when positioned in its intended position. Examples of suitable materials include REP Teflon, Nylon, PEBAX, silicone, polyurethane, PTFE (polytetrafluoroethylene), EVA (ethylvinylacetate), etc. The material may have a shore hardness of about 65 to 85 Shore D, preferably about 72 Shore D.

The material of the elongated securing member may be gradually varied from a hard material at the upper part of the securing member where the securing member is connected to the hearing aid to a flexible material at the lower part of the securing member.

The material can be melded onto a metal wire. The connector of the elongated securing member can be attached to the metal wire at the upper part and a material can then be melded onto the metal wire.

The elongated securing member may be made of a single material. At the upper part, the diameter of the securing member may be large, and at the lower part, the diameter may be small. The lower part of the securing member may therefore be more flexible than the upper part.

The securing member may be hollow. A metal wire may be inserted into the hollow space of the securing member making the securing member more rigid.

The elongated securing member may be cylindrical.

The elongated securing member may be rectangular. The width can be fixed along the length of the securing member and the height can be decreased from the upper part of the securing member down to the lower part of the securing member leading to a more flexible lower part of the securing member than the upper part.

The elongated securing member extends downwardly from its connection to the hearing aid housing along the hearing aid housing and beyond the bottom of the hearing aid housing so that the circumferential length of the contact area between parts of the hearing aid and the rear side of the pinna is increased by the presence of the elongated securing member for improved retention of the hearing aid housing in its intended position behind the pinna during use.

The elongated securing member may further extend upwardly from its connection to the hearing aid housing for additional gripping around the upper part of the pinna in the auricular sulcus for improved retention of the hearing aid housing in its intended position behind the pinna during use.

The elongated securing member may be long enough to permit it to bend around the ear lobe and possibly extend through the intertragical notch between the tragus and the antitragus for further improved retention of the hearing aid housing in its intended position behind the pinna during use.

The free end of the elongated securing member may be of increased thickness and rounded to avoid scratching the skin surface of the user for increased user comfort. In the event that the elongated securing member extends through the intertragical notch, a free end of increased thickness located behind the tragus and antitragus will further improve retention of the hearing aid housing in its intended position behind the pinna during use.

The elongated securing member may have a connector member fixed to it at the end that is interconnected with the hearing aid housing and a rounded end member of increased thickness fixed at its free end, e.g. provided by overmoulding by placing the elongated securing member into a meld which forms the end members. Alternatively, the connector member and the end member may be moulded first and then bonded to the elongated securing member.

The elongated securing member may be manufactured, possibly with the connector and rounded end member, in one unit in a number of standard sizes, for example with different lengths and with different arcuate bends.

The sound signal transmission member is typically flexible so that the sound signal transmission member is allowed to bend and provide the required arcuate propagation path of the signal from the output at the BTE housing to the earpiece, shell, or earmould in the ear canal of the user.

The sound signal transmission member and the elongated securing member may share the same connector for interconnection with the hearing aid housing. The common connector may for example be overmoulded onto both the sound signal transmission member and the elongated securing member by placing them in the mould that forms the connector during the moulding process.

As disclosed in EP 1 448 014 A1, it is also known to manufacture the sound tube with connector and earpiece in one unit in a large variety of standard sizes, for example with different lengths between the first and the second bend, e.g. 4 different lengths, and different lengths between the second bend and the earpiece, e.g. 2 different lengths, to fit the human anatomy of the ear of most users. Further, the sound tubes may be fitted with earpieces of different sizes e.g. 3 different standard sizes, or custom meld. Finally, the sound tube has to be manufactured with bends adapted to the right ear and bends adapted to the left ear. The present example leads to 48 (4*2*3*2) standard sizes of the unit to be manufactured and to be kept in stock by the hearing aid dispensers. Still further, the sound tube may be delivered with various diameters further multiplying the required number of standard sizes. These units may be combined with elongated securing members, possibly also manufactured in a number of standard sizes.

The elongated securing member may have a connector with a first end configured for mechanical interconnection with the hearing aid housing and a second end configured for mechanical connection with a corresponding connector of the sound signal transmission member, so that the sound signal transmission member and the hearing aid housing can be mechanically interconnected through the connector of the elongated securing member.

In this way, the variety of units to be kept in stock by a hearing aid dispenser is lowered since different standard sized elongated securing members can be combined by different standard sized sound signal transmission members by the dispenser.

Preferably, a sound signal transmission member, such as a sound tube, to be used with the elongated securing member is shorter than the corresponding sound signal transmission member used without the elongated securing member so that the BTE hearing aid housing remains in substantially the same position behind the ear whether it is used with the elongated securing member or not. Hereby, the microphone of the hearing aid is allowed to remain in the originally intended position behind the ear when the hearing aid is used with an elongated securing member.

The sound signal transmission member may further be provided with a connector, such as a plug, at the end to be connected with an earpiece for attachment of the sound signal transmission member to the earpiece, e.g. by bayonet coupling or gluing, etc.

In a preferred embodiment, the sound tube has an inner diameter of about 0.9 mm or less and an outer diameter of about 1.6 mm or less. The tube is preferably formed of a material with a durometer of 65 to 85 Shore D.

The elongated securing member may be formed into the desired arcuate shape by any known pre-forming process, such as, heat forming or UV light forming or moulding.

The earpiece, the sound tube, and the elongated securing member may be moulded to form one integrated part, or, the sound tube and the elongated securing member may be moulded to form one integrated part to be assembled with the hearing aid housing.

Preferably, the elongated securing member has a length that is substantially larger than a largest width of the elongated securing member, e.g. its length is larger than ten times its largest width. The elongated securing member may be cylindrical, such as circular cylindrical, and the elongated securing member may have a uniform cross-section along its length. Preferably, the elongated securing member has an outer diameter of about 1.0 to 1.6 mm, more preferred about 1.2 mm.

The elongated securing member is preferably produced from a material, which can be formed in a pre-formed shape and exhibits sufficient rigidity to hold the hearing aid housing behind the pinna and retains its shape when positioned in its intended position. Examples of suitable materials include REP Teflon, Nylon, PEBAX, silicone, polyurethane, PTFE (polytetrafluoroethylene), EVA (ethylvinylacetate), etc. The material may have a shore hardness of about 65 to 85 Shore D, preferably about 72 Shore D.

A BTE hearing aid includes: a hearing aid housing configured to be worn behind a pinna of a user; a sound signal transmission member for transmission of a hearing loss compensated output signal from a first end of the sound signal transmission member to an ear canal of the user at a second end of the sound signal transmission member; a connector at the first end of the sound signal transmission member for coupling the sound signal transmission member with the housing; and an elongated securing member with a first end coupled with the hearing aid housing, and a second end, the second end of the elongated securing member being a free end; wherein the elongated securing member extends from its first end along at least a part of the hearing aid housing, and is configured for improved retention of the hearing aid housing in its intended position behind the pinna of the user.

Optionally, the sound signal transmission member and the elongated securing member are moulded together.

Optionally, the connector comprises a hook having a first end that is coupled with the hearing aid housing and a second end that is coupled with the sound signal transmission member, wherein the connector is configured to reside across a top part of an auricular sulcus when the hearing aid is positioned in its intended position behind the pinna of the user, and wherein the elongated securing member has a ring-shaped connector at its first end that is positioned around the hook.

Optionally, the connector comprises a hook having an end that is coupled with the sound signal transmission member, wherein the connector is configured to reside across a top part of an auricular sulcus when the hearing aid is positioned in its intended position behind the pinna of the user, and wherein the elongated securing member has a ring-shaped connector at its first end that is positioned between the hook and the hearing aid housing when the elongated securing member is coupled with the hearing aid housing.

Optionally, the elongated securing member has a pre-formed arcuate shape that corresponds to an arcuate shape of a surface of an auricular sulcus for facilitating abutment of the elongated securing member with the auricular sulcus so that the elongated securing member provides a retaining grip against the surface of the auricular sulcus.

Optionally, the elongated securing member is flexible for allowing the elongated securing member to adopt an arcuate shape of a surface of an auricular sulcus of the user.

Optionally, the elongated securing member is resilient for improved retention of the hearing aid housing in its intended position behind the pinna of the user.

Optionally, the elongated securing member is bendable by the user to form a desired shape.

Optionally, the elongated securing member comprises a metal wire.

Optionally, the elongated securing member has a connector member fixed to the first end of the elongated securing member for coupling with the hearing aid housing; and wherein the connector of the sound signal transmission member is indirectly coupled to the hearing aid housing by coupling to the connector member of the elongated securing member.

Optionally, the connector is also configured to couple the elongated securing member with the hearing aid housing.

Optionally, the elongated securing member is removably coupled with the hearing aid housing.

Optionally, the hearing aid housing comprises an output, and wherein the first end of the elongated securing member is coupled with the hearing aid housing near the output of the hearing aid housing.

Optionally, the elongated securing member is configured to extend along the pinna in abutment with an outer surface of an auricular sulcus of the user.

An elongated securing member for coupling with a BTE hearing aid housing of a BTE hearing aid, includes: a first end configured for coupling with the BTE hearing aid housing that is to be worn behind a pinna of a user, the BTE hearing aid housing being coupled with a sound signal transmission member using a connector; a second end, the second end being a free end; and a body extending from the first end to the second end, wherein the body of the elongated securing member extends from the first end along at least a part of the BTE hearing aid housing for improved retention of the BTE hearing aid housing in its intended position behind the pinna of the user.

Optionally, the first end is configured for removable coupling with the hearing aid housing.

Optionally, the elongated securing member is coupled with the BTE hearing aid housing using the connector that couples the BTE hearing aid housing with the sound signal transmission member.

Optionally, at least a part of the elongated securing member is moulded together with the sound signal transmission member.

Optionally, the elongated securing member further includes a connector member for coupling the elongated securing member with the hearing aid housing, wherein the connector member and at least a part of the body are moulded together.

Optionally, the connector comprises a hook, and the elongated securing member further includes a ring-shaped connector at the first end that is positioned around the hook, wherein the hook has a first end that is coupled with the hearing aid housing and a second end that is coupled with the sound signal transmission member, and wherein the hook is configured to reside across a top part of an auricular sulcus when the hearing aid is positioned in its intended position behind the pinna of the user.

Optionally, the connector comprises a hook, and the elongated securing member further includes a ring-shaped connector at the first end that is positioned between the hook and the hearing aid housing when the elongated securing member is coupled with the hearing aid housing, wherein the hook has a first end that is coupled with the hearing aid housing and a second end that is coupled with the sound signal transmission member, and wherein the hook is configured to reside across a top part of an auricular sulcus when the hearing aid is positioned in its intended position behind the pinna of the user.

Optionally, the elongated securing member has a connector member fixed to the first end, and the connector is configured for coupling the sound signal transmission member to the connector member of the elongated securing member.

Optionally, the body has a pre-formed arcuate shape that corresponds to an arcuate shape of a surface of an auricular sulcus for facilitating abutment of the elongated securing member with the auricular sulcus so that the elongated securing member provides a retaining grip against the surface of the auricular sulcus.

Optionally, the body of the elongated securing member is flexible for allowing the body of the elongated securing member to adopt an arcuate shape of a surface of an auricular sulcus of the user.

Optionally, the body of the securing member is resilient for improved retention of the BTE hearing aid housing in its intended position behind the pinna of the user.

Optionally, the first end of the elongated securing member is coupled with the hearing aid housing near an output of the hearing aid housing.

Optionally, the elongated securing member is configured to extend along the pinna in abutment with an outer surface of an auricular sulcus of the user.

Other and further aspects and features will be evident from reading the following detailed description of the embodiments.

### DESCRIPTION OF THE DRAWING FIGURES

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only exemplary embodiments and are not therefore to be considered limiting to the scope of the claims.

FIG. 1 shows in perspective a BTE hearing aid with an elongated securing member in its intended position behind the right ear of a user,

FIG. 2 is a side view of a BTE hearing aid with an elongated securing member,

FIG. 3 is a side view and a front view of the elongated securing member of FIG. 2,

FIG. 4 is a side view of an elongated securing member made of different materials,

FIG. 5 is a side view of a BTE hearing aid with an elongated securing member,

FIG. 6 is a side view and a front view of the elongated securing member of FIG. 4,

FIG. 7 shows in perspective an elongated securing member and a sound signal transmission member with a common connector,

FIG. 8 shows in perspective the elongated securing member of FIG. 5,

FIG. 9 shows in perspective an elongated securing member with a connector,

FIG. 10 illustrates schematically various connectors for the elongated securing member, and

FIG. 11 illustrates schematically various mechanical interfaces for attaching the connector of the elongated securing member.

### DETAILED DESCRIPTION

Various embodiments are described hereinafter with reference to the figures. It should be noted that the figures are not necessarily drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. The claimed invention may be embodied in different forms and should not be construed as limited to the embodiments set forth herein. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The BTE hearing aid with an elongated securing member will now be described more fully hereinafter with reference to the accompanying drawings, in which various examples are shown. The claimed invention may be embodied in different forms not shown in the accompanying drawings and should not be construed as limited to the examples set forth herein.

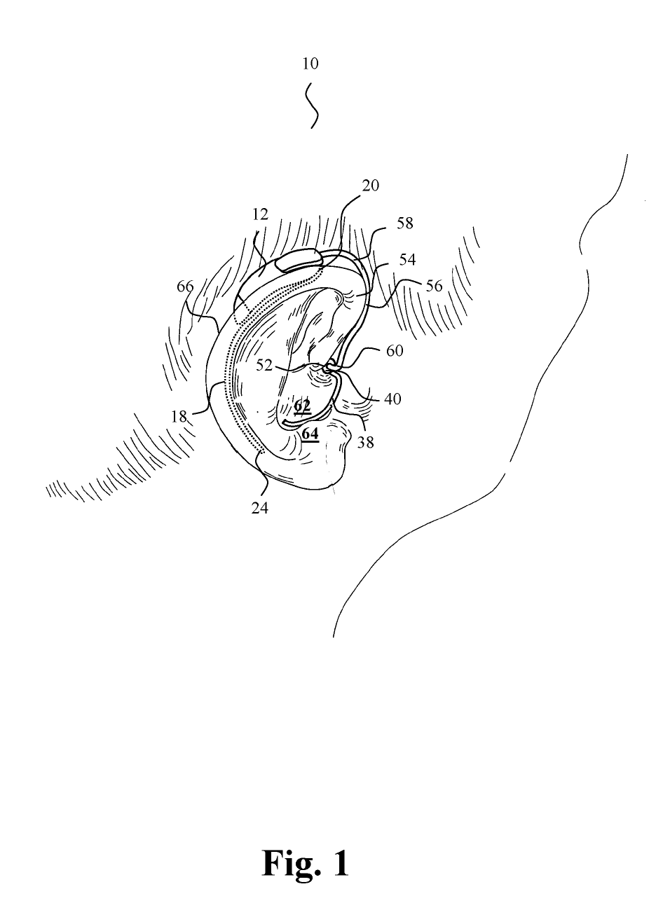

FIG. 1 shows in perspective a BTE hearing aid 10 with a new elongated securing member 18 (hidden behind the pinna as indicated by dotted lines). The BTE hearing aid 10 comprises a hearing aid housing 12, a sound signal transmission member in the form of a sound tube 56 having a pre-formed shape for conducting sound from the hearing aid housing 12 to the ear canal (only the entrance to the ear canal is visible), and an earpiece 52 attached to the sound tube 56 and inserted into the ear canal.

The hearing aid housing 12 is configured to be worn behind the pinna 54 of a user and contains a battery, a microphone, a processor, and a receiver (not shown) for generating sound that is transmitted through the sound tube 56.

The pre-formed shape of the sound tube 14 includes a first bend 58 extending from the case over the top of the ear of the user and a second bend 60 extending from an outside of the ear into an ear canal of the user when the hearing aid 10 is worn by the user.

The earpiece 52 is configured to fit within the ear canal and, preferably, allows sounds outside and within the ear to pass through the ear canal around the earpiece 52.

Further, the illustrated hearing aid 10 has an arcuate, preferably resilient, fibre 38 with one end 40 that is interconnected with the earpiece 52 or the sound tube 56. The fibre 38 is adapted for abutting a surface of the outer ear when the earpiece 52 has been inserted in the ear canal thereby providing retention of the earpiece 52 in the ear canal of the user, and in the illustrated embodiment, the fibre 38 is adapted for abutting the outer ear at the lower part of the concha 62 behind the antitragus 64 at which position the fibre 38 is substantially invisible and provides secure retention of the earpiece 42 in the ear canal.

The resilience of the fibre 38 allows the fibre 38 to apply a force to the earpiece 52 towards the ear canal to retain the earpiece 52 in a position in which the earpiece 52 is pressed against an anatomical feature within the ear canal.

The illustrated earpiece is provided in standard sizes (i.e. it is not custom made) and is comfortable to wear and aesthetical and the fibre 38 enables it to be securely and comfortably fastened in the ear canal of a user. The elongated securing member 18 extends between a first end 20 interconnected with the hearing aid housing 12 and a second free end 24 and abuts an outer surface of the auricular sulcus 66 when the hearing aid housing 12 is positioned in its intended position behind the pinna 54 of the user, whereby the elongated securing member 18 assists in gripping around the pinna 54 in the auricular sulcus 66 thereby providing improved retention of the hearing aid housing 12 in its intended position behind the pinna 54 of the user.

The first end 20 of the elongated securing member 18 is interconnected with the hearing aid housing 12 at the sound output of the hearing aid housing 12 in engagement with a connector for connection of the sound signal transmission member 56 with the sound output of the hearing aid housing 12 as more clearly illustrated in the following figures.

In this way, the elongated securing member 18 is preferably interconnected with the hearing aid housing 12 at a distance from the part of the hearing aid housing 12 accommodating a battery door and possible other parts of a user interface, such as an on/off switch, of the hearing aid 10. Hereby, the elongated securing member 18 is prevented from interfering with user access to the user interface so that user operation of the hearing aid 10 is not made more cumbersome by the presence of the elongated securing member 18.

The interconnection of the sound signal transmission member 56 to the hearing aid housing 12 and the interconnection of the elongated securing member 18 to the hearing aid housing 12 may be combined or may otherwise cooperate. The sound signal transmission member 56 may for example be interconnected with the elongated securing member 18 and they may be interconnected with the hearing aid housing 12 together, e.g. the sound signal transmission member 56 and the elongated securing member 18 may be moulded and moulded together in the same moulding process, and possibly moulded together with the connector for interconnection with a mating part of the hearing aid housing 12 at the sound output of the hearing aid housing 12.

The elongated securing member 18 may have a pre-formed arcuate shape that corresponds to the arcuate shape of the surface of the auricular sulcus 66 facilitating abutment of the elongated securing member 18 with the auricular sulcus 66 so that the elongated securing member 18 in cooperation with other parts of the BTE hearing aid 10 provides a retaining grip around the bottom of the auricular sulcus 66 formed by the interconnection of the pinna 54 with the head of the user.

The elongated securing member 18 may be flexible facilitating adaption of the arcuate shape of the elongated securing member 18 to the actual arcuate shape of the surface of the auricular sulcus 66 of the user in question and for improved user comfort. The flexibility allows the elongated securing member 18 to change its arcuate shape in response to possible changes of the arcuate shape of the auricular sulcus 66 of the user, e.g. due to movement of the jaw of the user, such as during chewing, yawning, smiling, talking, eating, etc.

The elongated securing member 18 may be resilient for improved retention of the hearing aid housing 12 in its intended position behind the pinna 54 of the user. The elongated securing member 18 may for example be manufactured with an arcuate shape having a smaller radius of curvature than the corresponding arcuate shape of the auricular sulcus 66 of the intended user, so that when the hearing aid housing 12 is positioned in its intended position behind the pinna 54 of the user the elongated securing member exerts an elastic pinching force around the pinna 54 for improved retention of the hearing aid housing 12 in its intended position and substantially without sacrificing user comfort.

The elongated securing member 18 may be manufactured in a material that can be shaped by the user whereby the user is allowed to adapt the elongated securing member 18 to the arcuate shape of the surface of the auricular sulcus 66 of the user. When no force is applied to the elongated securing member 18, the elongated securing member 18 maintains its current shape possibly with some flexibility for user comfort. For example, the elongated securing member 18 may have a metal wire inserted into a plastic tube allowing a user to bend the tube with the wire to any desired shape. After bending, the wire maintains its current shape.

The elongated securing member 18 extends downwardly from its connection to the hearing aid housing along and beyond the hearing aid housing so that the circumferential length of the contact area between parts of the hearing aid 10 and the rear side of the pinna 54 is increased by the presence of the elongated securing member 18 for improved retention of the hearing aid housing 12 in its intended position behind the pinna 54 during use.

The elongated securing member 18 may also extend in the opposite direction from its connection to the hearing aid housing 12 for additional gripping around the upper part of the pinna 54 in the auricular sulcus 66 for improved retention of the hearing aid housing 12 in its intended position behind the pinna 54 during use.

The elongated securing member 18 may be long enough to permit it to bend around the ear lobe 68 and possibly extend through the intertragical notch 70 between the tragus (not shown) and the antitragus 64 for further improved retention of the hearing aid housing 12 in its intended position behind the pinna 54 during use.

The free end 24 of the elongated securing member 18 may be of increased thickness and rounded to avoid scratching the skin surface of the user for increased user comfort. In the event that the elongated securing member 18 extends through the intertragical notch 70, a free end 24 of increased thickness located behind the tragus (not shown) and antitragus 64 will further improve retention of the hearing aid housing 12 in its intended position behind the pinna 54 during use.

The elongated securing member 18 may have a connector member (not shown) fixed to it at the end 20 that is interconnected with the hearing aid housing 12 and a rounded end member of increased thickness fixed at its free end 28, e.g. provided by overmoulding by placing the elongated securing member 18 into a meld which forms the end members. Alternatively, the connector member and the end member may be moulded first and then bonded to the elongated securing member 18.

The elongated securing member 18 may be manufactured, possibly with the connector and rounded end member, in one unit in a number of standard sizes, for example with different lengths and with different arcuate bends.

The sound signal transmission member 56 may be attached to a connector 14 for coupling of the sound tube to the BTE housing 12 containing the electronics of the hearing aid 10. The sound signal transmission member 56 may be flexible so that the sound signal transmission member 56 is allowed to bend and provide the required arcuate propagation path of the signal from the output at the BTE housing 12 to the earpiece 52, shell, or earmould in the ear canal of the user.

The sound signal transmission member 56 and the elongated securing member 18 may share the same connector for interconnection with the hearing aid housing 12. The common connector may for example be overmoulded onto both the sound signal transmission member 56 and the elongated securing member 18 by placing them in the mould that forms the connector during the moulding process.

The elongated securing member 18 may have a connector with a first end configured for mechanical interconnection with the hearing aid housing 12 and a second end configured for mechanical connection with a corresponding connector of the sound signal transmission member 56, so that the sound signal transmission member 56 and the hearing aid housing 12 can be mechanically interconnected through the connector of the elongated securing member 18.

The sound signal transmission member 56 may further be provided with a connector, such as a plug, at the end to be connected with an earpiece 52 for attachment of the sound signal transmission member 56 to the earpiece 52, e.g. by bayonet coupling or gluing, etc.

The sound tube may have an inner diameter of about 0.9 mm or less and an outer diameter of about 1.6 mm or less. The tube is preferably formed of a material with a durometer of 65 to 85 Shore D.

The elongated securing member 18 may be formed into the desired arcuate shape by any known pre-forming process, such as, heat forming or UV light forming or moulding.

The earpiece 52, the sound tube 56, and the elongated securing member 18 may be moulded to form one integrated part, or, the sound tube 56 and the elongated securing member 18 may be moulded to form one integrated part to be assembled with the hearing aid housing 12.

Preferably, the elongated securing member 18 has a length that is substantially larger than a largest width of the elongated securing member 18, e.g. its length is larger than ten times its largest width. The elongated securing member 18 may be cylindrical, such as circular cylindrical, and the elongated securing member 18 may have a uniform cross-section along its length. Preferably, the elongated securing member 18 has an outer diameter of about 1.0 to 1.6 mm, more preferred about 1.2 mm.

The elongated securing member 18 is preferably produced from a material, which can be formed in a pre-formed shape and exhibits sufficient rigidity to hold the hearing aid housing 12 behind the pinna and retains its shape when positioned in its intended position. Examples of suitable materials include REP Teflon, Nylon, PEBAX, silicone, polyurethane, PTFE (polytetrafluoroethylene), EVA (ethylvinylacetate), etc. The material may have a shore hardness of about 65 to 85 Shore D, preferably about 72 Shore D.

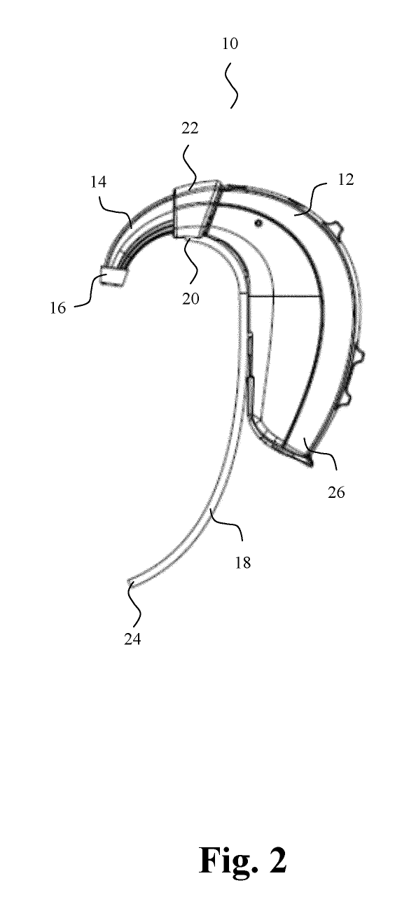

FIG. 2 is a side view of a BTE hearing aid 10. The BTE hearing aid 10 comprises a hearing aid housing 12, a connector, in the illustrated example a hook 14, for a sound tube (not shown), and an elongated securing member 18.

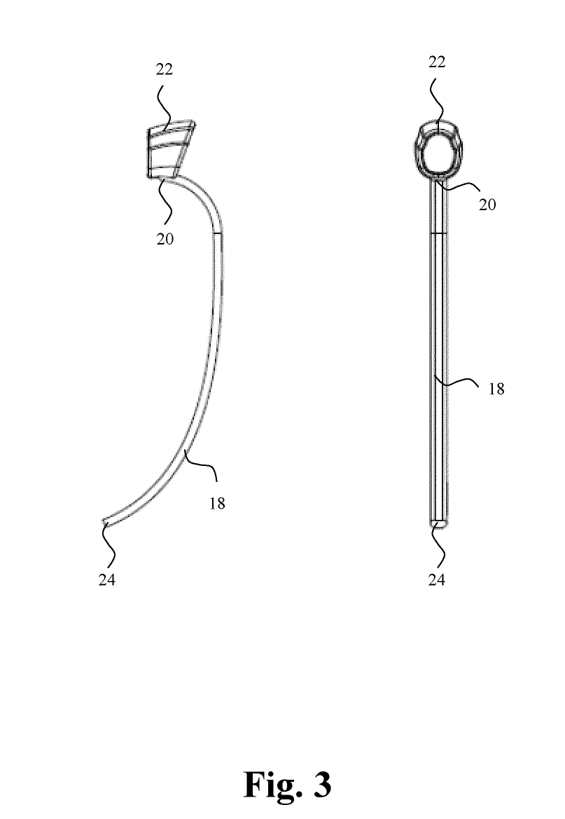

FIG. 3 is a side view and a front view of the elongated securing member of FIG. 2.

The hearing aid housing 12 is configured to be worn behind the ear of a user, i.e. behind the pinna of the user as illustrated in FIG. 1, and contains a battery, a microphone, a processor, and a receiver (not shown) for generating sound that is transmitted through the hook 14 and into the sound signal transmission member (not shown).

When the hearing aid 10 is positioned in its intended position behind the pinna of the user, the hook 14 resides across the top part of the auricular sulcus with the interconnection between the pinna and the head of the user and the sound tube (not shown) extends from the end 16 of the hook 14 towards the entrance to the ear canal of the user and has a bend extending from an outside of the ear into the ear canal of the user.

An earpiece (not shown) is connected to the end of the sound signal transmission member and configured to fit within the ear canal and, preferably, allows sounds outside and within the ear to pass through the ear canal around the earpiece.

Further, the hearing aid 10 has an arcuate, preferably resilient, elongated securing member 18 with one end 20 that is interconnected with the hearing aid housing 12 with a connector 22. During normal use, the elongated securing member 18 abuts a surface of the auricular sulcus on the rear side of the pinna and cooperates with the hearing aid housing 12 and other parts of the hearing aid 10 abutting a surface of the outer ear to provide gripping retention of the hearing aid housing 12 in its intended position behind the pinna of user.

The elongated securing member 18 extends between a free end 24 and the end 20 interconnected with the hearing aid housing and abuts an outer surface of the auricular sulcus when the hearing aid housing 12 is positioned in its intended position behind the ear of the user, whereby the elongated securing member 18 in cooperation with the hook 14 form pincers or a fork providing a grip around the pinna for improved retention of the hearing aid housing 12 in its intended position behind the pinna of the user.

The elongated securing member 18 is interconnected with the hearing aid housing 12 at a distance from the bottom of the hearing aid housing 12 typically accommodating a battery door and possible other parts of a user interface, such as an on/off switch, of the hearing aid 10. Hereby, the elongated securing member 18 is prevented from interfering with user access to components of the user interface so that user operation of the hearing aid 10 is not made more cumbersome by the presence of the elongated securing member 18.

In the illustrated hearing aid 10, the hook 14 is interconnected with the sound output of the hearing aid housing 12 at its first end and is interconnected with the sound signal transmission member at its second end 16 and the hook 14 is intended to reside across the top part of the auricular sulcus 66 when the hearing aid 10 is positioned in its intended position behind the pinna 54 of the user. The elongated securing member 18 has a ring-shaped connector 22 at its first end 20 that is slided onto the conical hook 14 when the elongated securing member 18 is interconnected with the hearing aid housing 12. The ring-shaped connector 22 may be bonded, glued, or welded to the hook 14. Part of the ring-shaped connector 22 may overlap or be positioned around the hearing aid housing 12.

The elongated securing member 18 may have a pre-formed arcuate shape that corresponds to the arcuate shape of the surface of the auricular sulcus facilitating abutment of the elongated securing member with the auricular sulcus so that the elongated securing member 18 in cooperation with other parts of the BTE hearing aid 10 provides a retaining grip around the pinna in the auricular sulcus.

The elongated securing member 18 may be flexible facilitating adaption of the arcuate shape of the elongated securing member 18 to the actual arcuate shape of the surface of the auricular sulcus of the user in question and for improved user comfort. The flexibility allows the elongated securing member 18 to change its arcuate shape in response to possible changes of the arcuate shape of the auricular sulcus of the user, e.g. due to movement of the jaw of the user, such as during chewing, yawning, smiling, talking, eating, etc.

The elongated securing member 18 may be resilient for improved retention of the hearing aid housing 12 in its intended position behind the pinna of the user. The elongated securing member 18 may for example be manufactured with an arcuate shape having a smaller radius of curvature than the corresponding arcuate shape of the auricular sulcus of the intended user, so that when the hearing aid housing 12 is positioned in its intended position behind the pinna of the user the elongated securing member 18 exerts an elastic pinching force around the pinna sufficient for improved retention of the hearing aid housing in its intended position and substantially without sacrificing user comfort.

The elongated securing member 18 may be manufactured in a material that can be shaped by the user whereby the user is allowed to adapt the elongated securing member 18 to the arcuate shape of the surface of the auricular sulcus of the user. When no force is applied to the elongated securing member 18, the elongated securing member 18 maintains its current shape possibly with some flexibility for user comfort. For example, the elongated securing member 18 may have a metal wire inserted into a plastic tube allowing a user to bend the tube with the wire to any desired shape. After bending, the wire maintains its current shape imparting the same shape to the plastic tube.

The elongated securing member 18 extends downwardly from its connection to the hearing aid housing 12 towards its free end 24 along the hearing aid housing 12 and beyond the bottom 26 of the hearing aid housing 12 so that the circumferential length of the contact area between parts of the hearing aid 10 and the rear side of the pinna is increased by the presence of the elongated securing member 18 for improved retention of the hearing aid housing 12 in its intended position behind the pinna during use.

The elongated securing member 18 may be long enough to permit it to bend around the ear lobe and possibly extend through the intertragical notch between the tragus and the antitragus for further improved retention of the hearing aid housing 12 in its intended position behind the pinna during use.

The free end 24 of the elongated securing member 18 may be of increased thickness and rounded to avoid scratching the skin surface of the user for increased user comfort. In the event that the elongated securing member 18 extends through the intertragical notch, a free end 24 of increased thickness located behind the tragus and antitragus will further improve retention of the hearing aid housing in its intended position behind the pinna during use.

The illustrated elongated securing member 18 has a connector member 22 fixed to it at the end 20 that is interconnected with the hearing aid housing 12 and a rounded end member 28 of increased thickness fixed at its free end 24 both of which are provided by overmoulding by placing the elongated securing member 18 into a meld forming these members 22, 28. Alternatively, the connector member 22 and the end member 28 may be moulded first and then bonded to the elongated securing member 18.

The elongated securing member 18 may be manufactured, possibly with connector 22 and rounded end member 28, in one unit in a number of standard sizes, for example with different standard lengths and with different standard arcuate bends.

A sound signal transmission member (not shown) in the form of a sound tube for transmission of acoustic sound emitted by a receiver in the hearing aid housing 12 to the ear canal of the user will be attached to the free end 16 of the hook 14 shown in FIG. 2. The sound tube (not shown) is typically flexible so that the sound tube is allowed to bend and provide the required arcuate propagation path of the acoustic sound signal from the output at the BTE housing to an earpiece, shell, or earmould in the ear canal of the user.

The connector 22 of the elongated securing member 18 has a first end 30 configured for mechanical interconnection with the hook 14 and a second end 32 configured for mechanical connection with the hearing aid housing 12 whereby the sound tube and the hearing aid housing 12 are mechanically interconnected through the connector 22 of the elongated securing member 18.

The connections may comprise any suitable kind of joint such as welded, glued, melted, fused or other simple mechanical connections, e.g. screwed connections.

The hook 14 to be used with the elongated securing member 18 is shorter than the corresponding hook used without the elongated securing member 18 so that the BTE hearing aid housing 12 remains in substantially the same position behind the ear whether it is used with the elongated securing member 18 or not. Hereby, the microphone of the hearing aid is allowed to remain in the originally intended position behind the ear when the hearing aid 10 is used with an elongated securing member 18.

Preferably, the elongated securing member 18 has an outer diameter of about 1.0 to 1.6 mm, more preferred about 1.2 mm.

The elongated securing member 18 is preferably produced from a material, which can be formed in a pre-formed shape and exhibits sufficient rigidity to hold the hearing aid housing behind the pinna and retains its shape when positioned in its intended position. Examples of suitable materials include REP Teflon, Nylon, PEBAX, silicone, polyurethane, PTFE (polytetrafluoroethylene), EVA (ethylvinylacetate), etc. The material may have a shore hardness of about 65 to 85 Shore D, preferably about 72 Shore D.

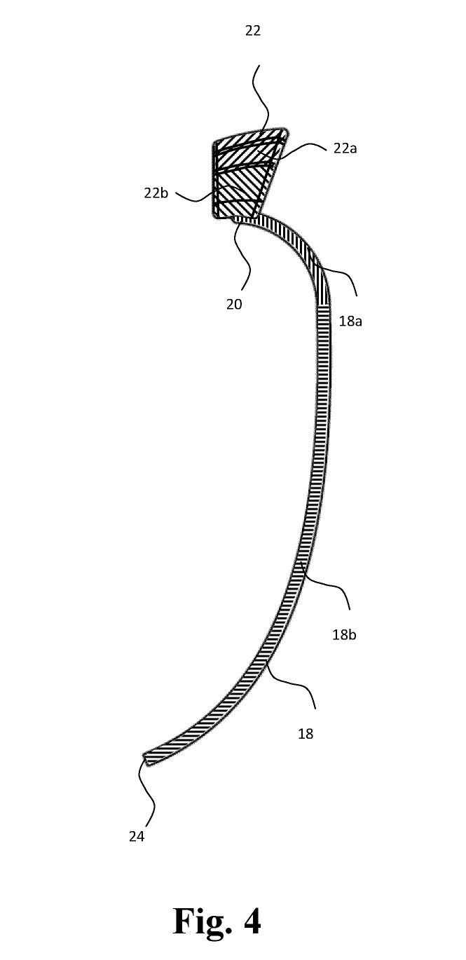

FIG. 4 shows a side view of an elongated securing member 18 made of different materials. The upper part 22a of the connector 22 of the illustrated elongated securing member 18 is made of an elastic material. The diameter of the upper part 22a is made smaller than the diameter of the part (not shown) of the hearing aid where the elongated securing member 18 is connected to the hearing aid. The use of an elastic material in combination with an undersized diameter as compared to the diameter of the hearing aid at the point of connection makes the connector of the elongated securing member fit tightly around the hearing aid like an elastic band.

The lower part 22b of the connector 22 of the illustrated elongated securing member 18 is made of a hard material. The use of a hard material for the lower part 22b of connector 22 of the elongated securing member 18 makes the connection to the elongated securing member 18 rigid.

Furthermore, when made of a hard material, the lower part 22b of the connector 22 of the elongated securing member 18 may be shaped to match the outer contour of the part of the hearing aid where the connector 22 of the elongated securing member 18 is connected to the hearing aid. This provides a rigid connection of the connector 22 to the hearing aid.

The material of the connector may be gradually varied from a hard material at the lower part 22b of the connector 22 where the connector 22 is attached to the elongated securing member 18 to an elastic material at the top part 22a of the connector 22 of the elongated securing member 18.

The connector 22 can be made of rubber which is attached to the elongated securing member 18.

The connector 22 may be made of a hard material. The inner contour of the connector 22 can be shaped to match the outer contour of the part of the hearing aid where the connector 22 of the elongated securing member 18 is attached to the hearing aid.

The upper elongated part 18a of the elongated securing member 18 may be made of a hard material. The use of a hard material at the upper part 18a of the elongated securing member 18 makes the connection of the elongated securing member 18 to the elongated securing member 18 rigid.

Further, the elongated securing member 18 will follow the shape of the hearing aid at the point of connection. This ensures that the securing member does not affect the placement of the hearing aid relative to its intended position behind the ear.

The contour of the upper part 18a facing the hearing aid may be shaped to follow the contour of the part of the hearing aid where the elongated securing member 18 is attached to the hearing aid. This allows for the elongated securing member 18 to be an integral part of the hearing aid.

The lower part 18b of the elongated securing member 18 may be resilient for improved retention of the hearing aid housing 12 in its intended position behind the pinna 54 of the user. The lower part 18b of the elongated securing member 18 may for example be manufactured with an arcuate shape having a smaller radius of curvature than the corresponding arcuate shape of the auricular sulcus 66 of the intended user, so that when the hearing aid housing 12 is positioned in its intended position behind the pinna 54 of the user, the lower part 18b of the elongated securing member exerts an elastic pinching force around the pinna 54 for improved retention of the hearing aid housing 12 in its intended position and substantially without sacrificing user comfort.

The lower part 18b of the elongated securing member 18 may be manufactured in a material that can be shaped by the user whereby the user is allowed to adapt the lower part 18b of the elongated securing member 18 to the arcuate shape of the surface of the auricular sulcus 66 of the user. When no force is applied to the lower part 18b of the elongated securing member 18, the lower part 18b of the elongated securing member 18 maintains its current shape possibly with some flexibility for user comfort. For example, the lower part 18b of the elongated securing member 18 may have a metal wire inserted into a plastic tube allowing a user to bend the tube with the wire to any desired shape. After bending, the wire maintains its current shape.

The lower part 18b of the elongated securing member 18 is preferably produced from a material, which can be formed in a pre-formed shape and exhibits sufficient rigidity to hold the hearing aid housing 12 behind the pinna and retains its shape when positioned in its intended position. Examples of suitable materials include REP

Teflon, Nylon, PEBAX, silicone, polyurethane, PTFE (polytetrafluoroethylene), EVA (ethylvinylacetate), etc. The material may have a shore hardness of about 65 to 85 Shore D, preferably about 72 Shore D.

The material for the elongated securing member 18 can be gradually varied from a hard material at the upper part 18a of the securing member 18 where the securing member 18 is connected to the hearing aid to a flexible material at the lower part 18b of the securing member 18.

The material may be moulded onto a metal wire. The connector 22 of the elongated securing member 18 can be attached to the metal wire at the upper part 18a and a material can then be moulded onto the metal wire.

The elongated securing member 19 may be made of a single material. At the upper part 18a, the diameter of the securing member 18 is large and at the lower part 18b, the diameter is small. The lower part 18b of the securing member 18 is therefore more flexible than the upper part 18a.

The securing member 18 may be hollow. A metal wire may be inserted into the hollow space of the securing member 18 making the securing member more rigid.

The elongated securing member 18 may be cylindrical.

The elongated securing member 18 may be rectangular. The width may be fixed along the length of the securing member 18, and the height may be decreased from the upper part of the securing member down to the lower part of the securing member 18. The lower part 18b of the securing member 18 is therefore more flexible than the upper part 18a.

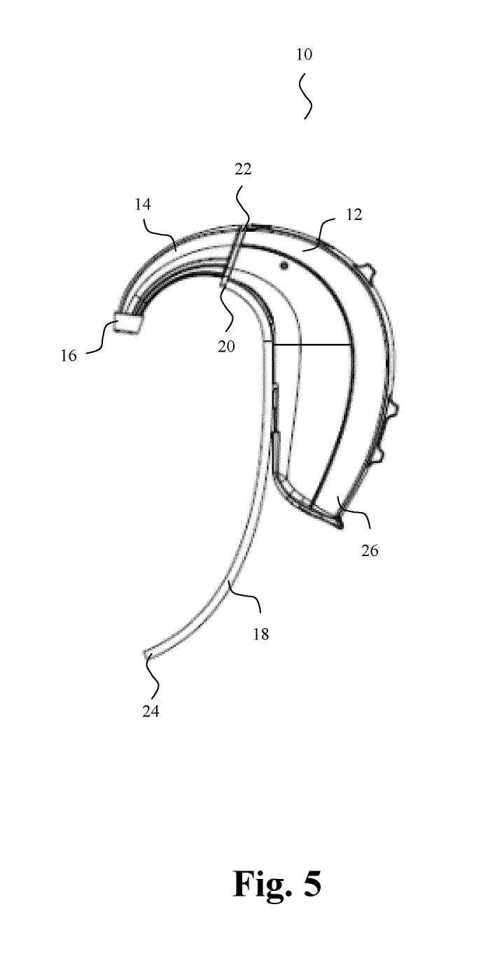

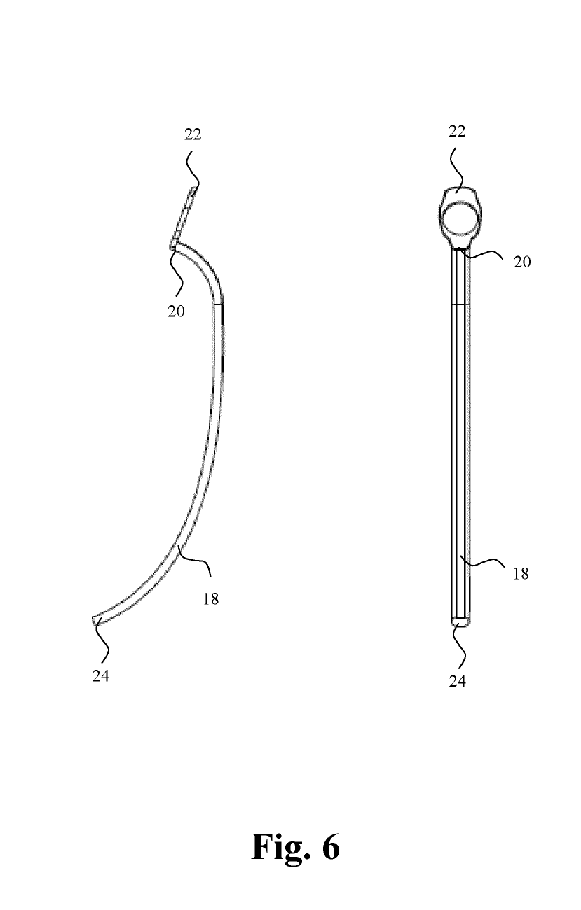

FIG. 5 is a side view of a BTE hearing aid with an elongated securing member 18, and FIG. 6 is a side view and a front view of the elongated securing member 18 of FIG. 5. The connector 22 of FIGS. 4 and 5 is very thin and configured to be bonded or glued between the hearing aid housing 12 and the hook 14. Apart from this, the description of the hearing aids 10 shown in FIGS. 1-3 is also valid for FIGS. 4 and 5.

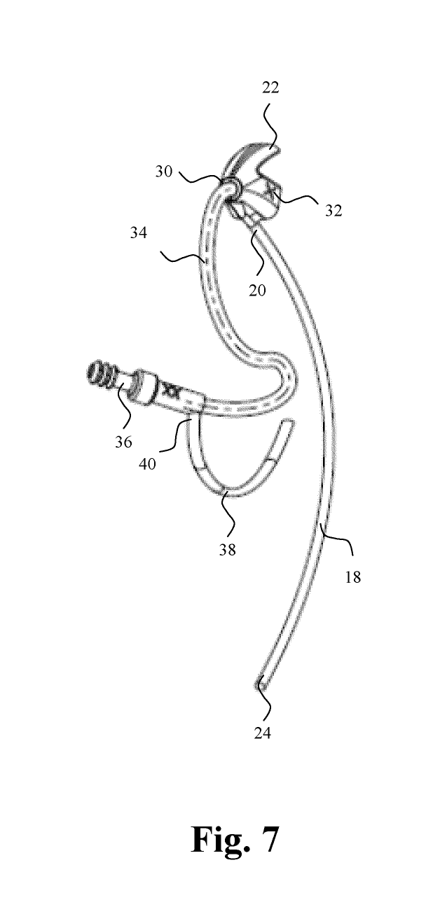

FIG. 7 shows in perspective an elongated securing member 18 with a connector 22, and a sound tube 34 having a pre-formed shape for conducting sound from the hearing aid housing 12 to the ear canal (not shown). An earpiece (not shown) will be attached to the illustrated free end 36 of the sound tube 34 and inserted into the ear canal of the user.

Further, an arcuate and resilient fibre 38 is connected to the sound tube at one end 40 and has a free opposite end 42. When the earpiece (not shown) has been inserted into the ear canal of the user, the fibre 38 abuts a surface of the outer ear at the lower part of the concha behind the antitragus at which position the fibre 38 is substantially invisible and provides secure retention of the earpiece (not shown) in the ear canal.

The resilience of the fibre 38 allows the fibre to apply a force to the earpiece (not shown) towards the ear canal to retain the earpiece in a position in which the earpiece is pressed against an anatomical feature within the ear canal.

Apart from this, the description of the hearing aids 10 shown in FIGS. 1-3 is also valid for FIGS. 6 and 7.

A BTE hearing aid with a similar arrangement of sound tube and fibre is disclosed in EP 1 448 014 A1.

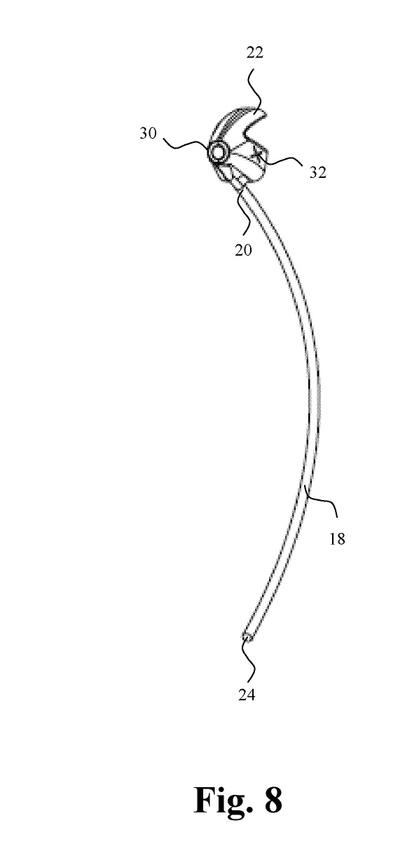

FIG. 8 shows in perspective the elongated securing member of FIG. 7 without the sound tube.

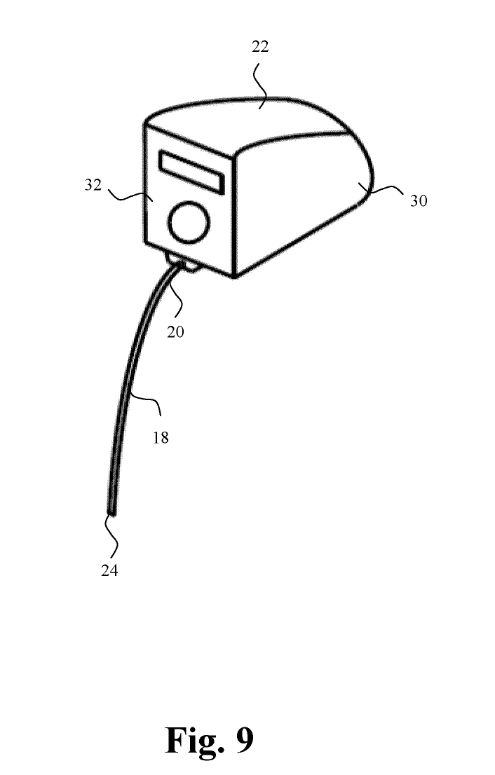

FIG. 9 illustrates an elongated securing member 18 with a connector 22 with a first end 30 for connection with a sound signal transmission member, such as a sound tube, possibly provided with a mating connector, and a second end 32 for connection with a BTE hearing aid housing 12. The sound signal transmission member (not shown) may be connected to an earpiece or a shell or an earmould for insertion into the ear canal.

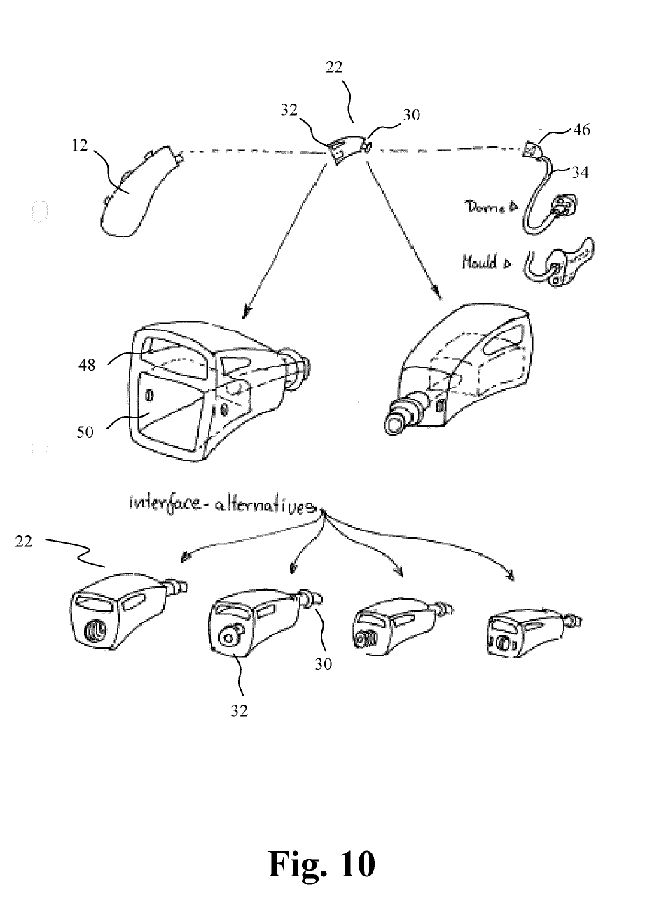

FIG. 10 is a perspective view of various connectors 22 of the elongated securing member of FIG. 9 (not shown) fitting various types of couplings 44 of BTE hearing aid housings 12 to corresponding various types of couplings 46 of sound signal transmission members 34. The illustrated connector 22 has a first end 30 configured for connection with a sound tube connector 46 comprising a generally cylindrical member extending along a longitudinal axis with a bead for snap coupling by insertion into the sound tube connector 46 for secure attachment by resilience of the member and connector. The second end 32 of the connector 22 is geometrically adapted for connection with the hearing aid housing 12.

The connector 22 may have a compartment 48 for accommodation of a cerumen guard that is positioned in the transmission path of sound emitted by the receiver and protecting the BTE housing 12 from entrance of cerumen. Alternatively, the compartment 48 may contain an acoustic filter for improved sound quality. Alternatively, the cerumen guard is moulded as an integral part of the connector 22.

The connector 22 may also have a compartment 50 for accommodation of a wind noise or moisture filter for suppression of wind noise emitted by the receiver. Further the connector 22 may have a compartment (not shown) for accommodation of a left/right marking.

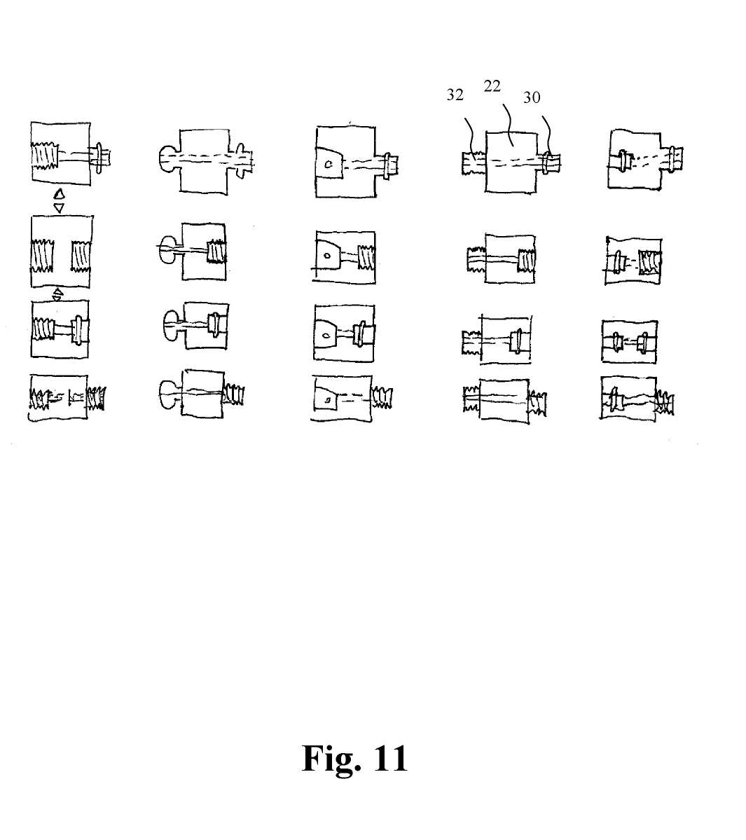

FIG. 11 schematically illustrates a large set of connectors 22 adaptors of elongated securing members (not shown). The upper row shows connectors 22 also shown in FIG. 10 while the other rows illustrate alternative coupling geometries between sound signal transmission member connectors and the first end 30 of the connector 22. The person skilled in the art will appreciate that other coupling principles and geometries may also be contemplated.

As disclosed in EP 1 448 014 A1, it is known to manufacture a sound tube 56 with connector and earpiece 52 in one unit in a large variety of standard sizes, for example with different lengths between the first and the second bend, e.g. 4 different lengths, and different lengths between the second bend and the earpiece 52, e.g. 2 different lengths, to fit the human anatomy of the ear of most users. Further, the sound tubes may be fitted with earpieces 52 of different sizes e.g. 3 different standard sizes, or custom meld. Finally, the sound tube 56 has to be manufactured with bends adapted to the right ear and bends adapted to the left ear. The present example leads to 48 (4*2*3*2) standard sizes of the unit to be manufactured and to be kept in stock by the hearing aid dispensers. Still further, the sound tube 56 may be delivered with various diameters further multiplying the required number of standard sizes. These units may be combined with elongated securing members 18, possibly also manufactured in a number of standard sizes.

With the connector 22 illustrated in FIGS. 8-10, sound signal transmission member 56 from one manufacturer can be mechanically interconnected with the hearing aid housing 12 of another manufacturer through the connector 22 of the elongated securing member 18.

In this way, the variety of units to be kept in stock by a hearing aid dispenser is lowered because the provision of the connector 22 eliminates the need for keeping sound tube units in stock with different types of proprietary connectors from different manufacturers. For example, if a sound tube unit is produced in p different sizes and with q different coupling mechanisms (by q different manufacturers), then according to the prior art, p*q different parts must be manufactured and kept in stock for every combination of size and coupling mechanism to be available. The connector 22 reduces the required number of parts to p+q (p sizes of the sound tube plus q different adaptors).

Preferably, a sound signal transmission member 56, such as a sound tube 56, to be used with the elongated securing member 18 is shorter than the corresponding sound signal transmission member 56 used without the elongated securing member 18 so that the BTE hearing aid housing 12 remains in substantially the same position behind the ear whether it is used with the elongated securing member 18 or not. Hereby, the microphone of the hearing aid 10 is allowed to remain in the originally intended position behind the ear when the hearing aid 10 is used with an elongated securing member 18.

Although particular embodiments have been shown and described, it will be understood that they are not intended to limit the claimed inventions, and it will be obvious to those skilled in the art that various changes and modifications may be made without departing from the spirit and scope of the claimed inventions. The specification and drawings are, accordingly, to be regarded in an illustrative rather than restrictive sense. The claimed inventions are intended to cover alternatives, modifications, and equivalents.

1. A BTE hearing aid comprising:
a hearing aid housing configured to be worn behind a pinna of a user;
a sound signal transmission member for transmission of a hearing loss compensated output signal from a first end of the sound signal transmission member to an ear canal of the user at a second end of the sound signal transmission member;
a connector at the first end of the sound signal transmission member for coupling the sound signal transmission member with the housing; and
an elongated securing member with a first end coupled with the hearing aid housing, and a second end, the second end of the elongated securing member being a free end;
wherein the elongated securing member extends from its first end along at least a part of the hearing aid housing, and is configured for improved retention of the hearing aid housing in its intended position behind the pinna of the user.

2. The BTE hearing aid according to claim 1, wherein the sound signal transmission member and the elongated securing member are moulded together.

3. The BTE hearing aid according to claim 1, wherein the connector comprises a hook having a first end that is coupled with the hearing aid housing and a second end that is coupled with the sound signal transmission member, wherein the connector is configured to reside across a top part of an auricular sulcus when the hearing aid is positioned in its intended position behind the pinna of the user, and wherein the elongated securing member has a ring-shaped connector at its first end that is positioned around the hook.

4. The BTE hearing aid according to claim 1, wherein the connector comprises a hook having an end that is coupled with the sound signal transmission member, wherein the connector is configured to reside across a top part of an auricular sulcus when the hearing aid is positioned in its intended position behind the pinna of the user, and wherein the elongated securing member has a ring-shaped connector at its first end that is positioned between the hook and the hearing aid housing when the elongated securing member is coupled with the hearing aid housing.

5. The BTE hearing aid according to claim 1, wherein the elongated securing member has a pre-formed arcuate shape that corresponds to an arcuate shape of a surface of an auricular sulcus for facilitating abutment of the elongated securing member with the auricular sulcus so that the elongated securing member provides a retaining grip against the surface of the auricular sulcus.

6. The BTE hearing aid according to claim 1, wherein the elongated securing member is flexible for allowing the elongated securing member to adopt an arcuate shape of a surface of an auricular sulcus of the user.

7. The BTE hearing aid according to claim 1, wherein the elongated securing member is resilient for improved retention of the hearing aid housing in its intended position behind the pinna of the user.

8. The BTE hearing aid according to claim 1, wherein the elongated securing member is bendable by the user to form a desired shape.

9. The BTE hearing aid according to claim 9, wherein the elongated securing member comprises a metal wire.

10. The BTE hearing aid according to claim 1, wherein the elongated securing member has a connector member fixed to the first end of the elongated securing member for coupling with the hearing aid housing; and
wherein the connector of the sound signal transmission member is indirectly coupled to the hearing aid housing by coupling to the connector member of the elongated securing member.

11. The BTE hearing aid according to claim 1, wherein the connector is also configured to couple the elongated securing member with the hearing aid housing.

12. The BTE hearing aid according to claim 1, wherein the elongated securing member is removably coupled with the hearing aid housing.

13. The BTE hearing aid according to claim 1, wherein the hearing aid housing comprises an output, and wherein the first end of the elongated securing member is coupled with the hearing aid housing near the output of the hearing aid housing.

14. The BTE hearing aid according to claim 1, wherein the elongated securing member is configured to extend along the pinna in abutment with an outer surface of an auricular sulcus of the user.

15. An elongated securing member for coupling with a BTE hearing aid housing of a BTE hearing aid, comprising:
a first end configured for coupling with the BTE hearing aid housing that is to be worn behind a pinna of a user, the BTE hearing aid housing being coupled with a sound signal transmission member using a connector;
a second end, the second end being a free end; and
a body extending from the first end to the second end, wherein the body of the elongated securing member extends from the first end along at least a part of the BTE hearing aid housing for improved retention of the BTE hearing aid housing in its intended position behind the pinna of the user.

16. The elongated securing member according to claim 15, wherein the first end is configured for removable coupling with the hearing aid housing.

17. The elongated securing member according to claim 15, wherein the elongated securing member is coupled with the BTE hearing aid housing using the connector that couples the BTE hearing aid housing with the sound signal transmission member.

18. The elongated securing member according to claim 15, wherein at least a part of the elongated securing member is moulded together with the sound signal transmission member.

19. The elongated securing member according to claim 15, further comprising a connector member for coupling the elongated securing member with the hearing aid housing, wherein the connector member and at least a part of the body are moulded together.

20. The elongated securing member according to claim 15, wherein the connector comprises a hook, and the elongated securing member further includes a ring-shaped connector at the first end that is positioned around the hook, wherein the hook has a first end that is coupled with the hearing aid housing and a second end that is coupled with the sound signal transmission member, and wherein the hook is configured to reside across a top part of an auricular sulcus when the hearing aid is positioned in its intended position behind the pinna of the user.

21. The elongated securing member according to claim 15, wherein the connector comprises a hook, and the elongated securing member further includes a ring-shaped connector at the first end that is positioned between the hook and the hearing aid housing when the elongated securing member is coupled with the hearing aid housing, wherein the hook has a first end that is coupled with the hearing aid housing and a second end that is coupled with the sound signal transmission member, and wherein the hook is configured to reside across a top part of an auricular sulcus when the hearing aid is positioned in its intended position behind the pinna of the user.

22. The elongated securing member according to claim 15, wherein the elongated securing member has a connector member fixed to the first end, and the connector is configured for coupling the sound signal transmission member to the connector member of the elongated securing member.

23. The elongated securing member according to claim 15, wherein the body has a pre-formed arcuate shape that corresponds to an arcuate shape of a surface of an auricular sulcus for facilitating abutment of the elongated securing member with the auricular sulcus so that the elongated securing member provides a retaining grip against the surface of the auricular sulcus.

24. The elongated securing member according to claim 15, wherein the body of the elongated securing member is flexible for allowing the body of the elongated securing member to adopt an arcuate shape of a surface of an auricular sulcus of the user.

25. The elongated securing member according to claim 15, wherein the body of the securing member is resilient for improved retention of the BTE hearing aid housing in its intended position behind the pinna of the user.

26. The elongated securing member according to claim 15, wherein the first end of the elongated securing member is coupled with the hearing aid housing near an output of the hearing aid housing.

27. The elongated securing member according to claim 15, wherein the elongated securing member is configured to extend along the pinna in abutment with an outer surface of an auricular sulcus of the user.
